(19) United States
(12) Patent Application Publication
(10) Pub. No.: US 2014/0297636 A1
(43) Pub. Date: Oct. 2, 2014

(54) INFORMATION PROCESSING TECHNIQUE FOR CONFIGURATION MANAGEMENT DATABASE

(71) Applicant: FUJITSU LIMITED, Kawasaki-shi (JP)

(72) Inventors: Shinya KITAJIMA, Inagi (JP); Shinji KIKUCHI, Yokohama (JP); Masazumi MATSUBARA, Yamato (JP); Yasuhide MATSUMOTO, Kawasaki (JP)

(73) Assignee: FUJITSU LIMITED, Kawasaki-shi (JP)

(21) Appl. No.: 14/307,549

(22) Filed: Jun. 18, 2014

Related U.S. Application Data
(63) Continuation of application No. PCT/JP2012/051844, filed on Jan. 27, 2012.

(51) Int. Cl. G06F 17/30

(52) U.S. Cl. CPC G06F 17/30386; G06F 17/30345
USPC 707/736

(57) ABSTRACT

Upon receiving a request to change an attribute value for a certain configuration item (CI), it is determined whether a first pattern exists that includes a first condition, which is satisfied with change relating to the request. Each pattern includes a first condition relating to a certain change of an attribute value for a first CI and a second condition relating to an attribute value, which is to be changed at a same timing as the certain change, for a second CI that has a predetermined relation with the first CI. Upon determining that there is the first pattern, it is determined whether a second condition of the first pattern is satisfied, based on another request to be processed with the request or the like. Upon determining that the second condition of the first pattern is satisfied, a predetermined processing is performed.

### CROSS-REFERENCE TO RELATED APPLICATIONS

This application is a continuing application, filed under 35 U.S.C. section 111(a), of International Application PCT/JP2012/051844, filed on Jan. 27, 2012, the entire contents of which are incorporated herein by reference.

### FIELD

This technique relates to a management technique of a computer system.

### BACKGROUND

In order to provide configuration information of an Information and Communication Technology (ICT) system for clients of the ICT system, there is a case where a Federated Configuration Management Database (FCMDB or Federated CMDB) is used as illustrated in FIG. 1. The FCMDB is a DB to provide integrated views for the clients by virtually integrating plural Management Data Repositories (MDR). The MDR holds operation management data for the ICT system, and corresponds to a DB of operation management middleware. The type and/or amount of data is different for each MDR, and as illustrated in FIG. 1, MDR1 holds design information, MDR2 holds product information, MDR3 holds performance information and MDR4 holds configuration information.

The FCMDB stores data regarding configuration items (CI or component item) and relationships among the configuration items. The CI is a part such as a server, storage product, software or the like, which is included in the ICT system.

For example, in FIG. 1, data of the configuration component C on the FCMDB includes data into which configuration information Cd in MDR4, performance information Cc in MDR3 and design information Ca in MDR1 are integrated.

The MDR may be updated by manually inputting data by an administrator or the like or by automatically obtaining data from the ICT system. After that, the update of MDR is reflected to the FCMDB.

Such a processing to reflect the update of the MDR to the FCMDB is not performed for each update of data regarding one CI in the MDR. Then, a mode is considered that data of the CIs updated within an update interval, which is determined by any method, is transmitted collectively as plural update requests to the FCMDB. In such a case, for example, in case where the update intervals of plural MDRs are different, even when CIs are updated at the almost same timing, the update requests for data regarding such CIs may be transmitted at different timings. As illustrated in FIG. 2, when the update interval of MDR2 is shorter than that of MDR1, the update requests for update of Switch1, update of Server1 and update of Service1 are transmitted from the MDR1 to the FCMDB, however, only update requests for update of Switch1 and update of Server1 are transmitted from the MDR2 to the FCMDB, although the similar updates are performed in the MDR2. In other words, the update request for update of Service1 is transmitted from the MDR2 to the FCMDB a little later.

Moreover, in case where the update of the MDR is manually performed, the administrator may forget the update to be performed simultaneously for data regarding CI.

When there is difference between the state of a CI in the FCMDB and the state of an actual CI, any trouble occurs when, by referring to the FCMDB, the configuration change is instructed, service deployment is instructed or patch is applied. For example, regardless of a state where Service1 that is an associated CI cannot be used because a network disconnection error occurs, a case occurs that the reflection to the FCMDB is not performed simultaneously because of any reason. In such a case, after confirming that the attribute value of an attribute “Status” of Service1 is still “normal”, the configuration change to provide Service1 for a customer may be performed. Of course, when the customer tries to use Service1, it is impossible to use Service1, because of the error.

As a method for solving such a problem, there is a method for checking other CIs to be updated, at the update of a CI, by using the number of times that CIs are simultaneously updated and a ratio of simultaneous updates of CIs at the update of the CI. However, according to this method, there is a problem that the calculation amount becomes very large when there are the huge number of CIs.
Non-Patent Document 1: Nadi, S et al., “Does the Past Say It All? Using History to Predict Change Sets in a CMDB”, CSMR2010, IEEE, pp. 97-106, March 2010
Patent Document 1: Japanese Laid-open Patent Publication No. 62-214438
Patent Document 2: Japanese Laid-open Patent Publication No. 2006-164136
Patent Document 3: Japanese Laid-open Patent Publication No. 2007-80171
Patent Document 4: Japanese Examined Patent Application Publication No. 03-3259

However, there is no conventional technique for detecting a problem such as update omission of the configuration information with a low processing load.

### SUMMARY

An information processing method relating to a first aspect of this technique includes (A) upon receiving a request to change an attribute value of a certain attribute for a certain configuration item included in a system, determining whether there is a first pattern that includes a first condition, which is satisfied with change relating to the request, among plural patterns, wherein each of the plural patterns includes a first condition relating to a certain change of an attribute value of an attribute for a first configuration item included in the system and a second condition relating to an attribute value of an attribute, which is to be changed at a same timing as the certain change, for a second configuration item that has a predetermined relation with the first configuration item; (B) upon determining that there is the first pattern, determining whether a second condition of the first pattern is satisfied, based on at least either of another request to be processed with the request and a data storage unit that stores information of configuration items included in the system and whose information of the configuration items is updated by the request; and (C) upon determining the second condition of the first pattern is satisfied, performing a predetermined processing.

An information processing method relating to a second aspect of this technique includes (A) determining, for each of plural requests, each of which an attribute value of an attribute for a configuration item included in a system is to be changed, whether it is possible to reach a configuration item relating to another request of the plural requests from a configuration item relating to the request, by tracing one or plural relationships between configuration items, within a predetermined range among predefined relationships among configuration items included in the system, wherein the plural requests are received at predetermined timings that are presumed to be simultaneous; and (B) upon determining that it is possible to reach a first configuration item relating to a first request of the plural requests from a second configuration item relating to a second request, generating a pattern that includes a first condition relating to change of an attribute value of an attribute for the second configuration relating to the second request and a second condition relating to change of an attribute value of an attribute for the first configuration relating to the first request.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram to explain FCMDB;

FIG. 2 is a diagram to explain update of the FCMDB;

FIG. 3 is a diagram depicting a system configuration example relating to this embodiment;

FIG. 4 is a diagram depicting an example of CIs stored in the FCMDB;

FIG. 5 is a diagram depicting examples of update requests that were received at timings that are presumed to be simultaneous;

FIG. 6 is a diagram depicting an example of a generated update pattern;

FIG. 7 is a diagram depicting an example of data stored in the FCMDB;

FIG. 8 is a diagram depicting an example of a relationship between configuration items (CIs);

FIG. 9 is a diagram depicting a data example of CI;

FIG. 10 is a diagram depicting a data example of CI;

FIG. 11 is a diagram depicting a data example of the relationship;

FIG. 12 is a diagram depicting a main processing flow in this embodiment;

FIG. 13 is a diagram depicting a processing flow of a relation update processing;

FIG. 14A is a diagram depicting an example of the relationship between CIs;

FIG. 14B is a diagram depicting an example of change of the relationship;

FIG. 14C is a diagram depicting an example of deletion of the relationship;

FIG. 14D is a diagram depicting an example of deletion of the CI;

FIG. 15 is a diagram depicting a processing flow of an update pattern generation processing;

FIG. 16A is a diagram depicting an example of data before change of a configuration item Switch1;

FIG. 16B is a diagram depicting an example of data after change of the configuration item Switch1;

FIG. 17A is a diagram depicting an example of data before change of Service1;

FIG. 17B is a diagram depicting an example of data after change of Service1;

FIG. 18 is a diagram depicting a processing flow of the update pattern generation processing;

FIG. 19 is a diagram to explain the number of hops;

FIG. 20 is a diagram depicting an example of data stored in an update pattern storage unit;

FIG. 21 is a diagram depicting a processing flow of a pattern application processing;

FIG. 22 is a diagram depicting a processing flow of the pattern application processing;

FIG. 23 is a diagram depicting a processing flow of a confidence degree update processing; and

FIG. 24 is a functional block diagram of a computer.

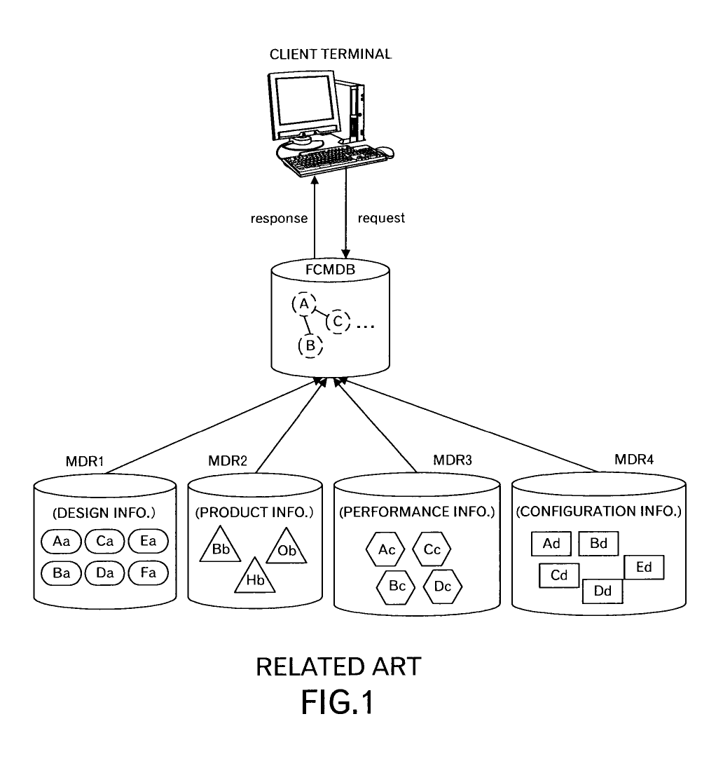

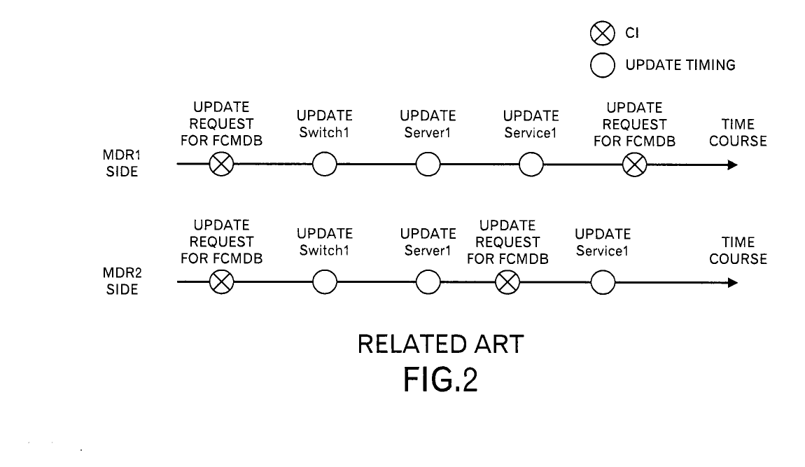

### DESCRIPTION OF EMBODIMENTS

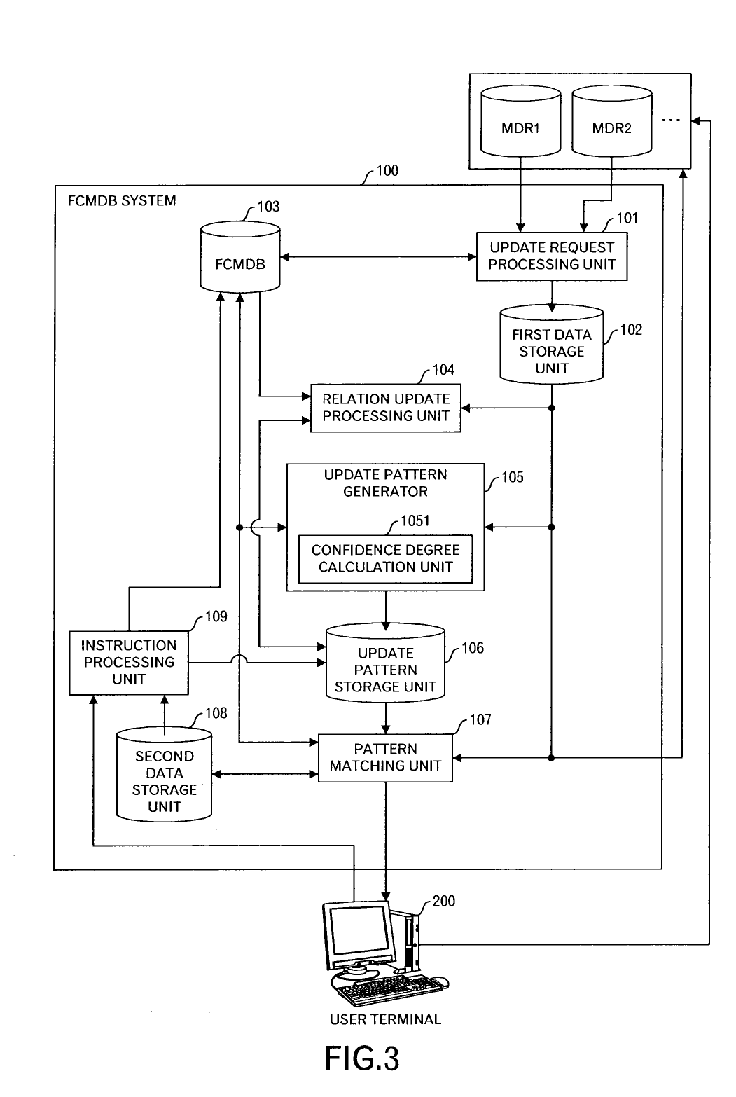

FIG. 3 illustrates an outline of a system relating to an embodiment of this technique. A FCMDB system 100 that is a main information processing apparatus relating to this embodiment is connected with plural MDRs (in FIG. 3, MDRs 1 and 2) and one or plural user terminals 200 through a computer network. In this embodiment, it is assumed that an update request to reflect data of an updated CI in its own MDR to the FCMDB from each MDR is transmitted to the FCMDB system 100. The user terminal 200 is a terminal apparatus such as a personal computer that is operated, for example, by an administrator. The user terminal 200 may update MDR according to instructions from the administrator.

Then, the FCMDB system 100 has an update request processing unit 101, a first data storage unit 102, a FCMDB 103, a relation update processing unit 104, an update pattern generator 105, an update pattern storage unit 106, a pattern matching unit 107, a second data storage unit 108 and an instruction processing unit 109.

The update request processing unit 101 receives an update request from each MDR, and stores the update request into the first data storage unit 102. In the following, update requests for CIs that are presumed to be simultaneously updated are collectively processed. The update requests for CIs that are presumed to be simultaneously updated may include a certain update request and other update requests that are received within a predetermined time since the certain update request was received. Moreover, time slots are defined in the update request processing unit 101, and the update requests that are received in the same time slot may be treated as the update requests for CIs that are presumed to be simultaneously updated. Furthermore, according to circumstances, plural update requests that are received at once may be treated as the update requests for CIs that are presumed to be simultaneously updated.

In this embodiment, the update request processing unit 101 updates the FCMDB 103 according to the update requests, and stores data before change in the first data storage unit 102 for the later processing.

The relation update processing unit 104 processes the update request for the relationship between configuration items, which is stored in the first data storage unit 102, to update an update pattern stored in the update pattern storage unit 106. The update pattern generator 105 performs a processing for generating an update pattern by using the update requests for CIs that are presumed to be simultaneously updated, which are stored in the first data storage unit 102, and stores the generated update pattern into the update pattern storage unit 106. The update pattern generator 105 includes a confidence degree calculation unit 1051.

The pattern matching unit 107 applies the update pattern stored in the update pattern storage unit 106 to the update requests for CIs that are presumed to be simultaneously updated, which are stored in the first data storage unit 102, to perform a processing to extract attributes of other CIs, which should be simultaneously updated, however, have not been updated, and stores processing results into the second data storage unit 108, and notifies the user of processing results after performing a predetermined processing.

The instruction processing unit 109 receives an update instruction from the user terminal 200 for the attributes of CI to be updated, and updates the confidence degree of the update pattern in the update pattern storage unit 106 and/or update the FCMDB 103.

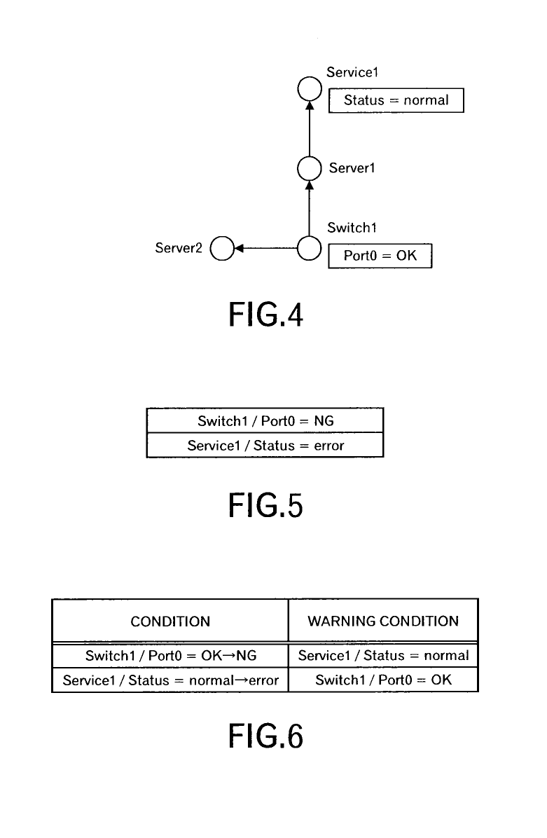

In this embodiment, an update pattern is generated from plural update requests for CIs that are presumed to be simultaneously updated. For example, it is assumed that CIs as illustrated in FIG. 4 are stored in the FCMDB 103. In other words, CIs include Switch1, Server1, Server2 and Service1. Then, a Relationship from Switch1 to Server2, a Relationship from Switch1 to Server1, a Relationship from Server1 to Service1 are provided. Moreover, an attribute value “OK” is set to an attribute “Port0” of Switch1, and an attribute value “normal” is set to an attribute “Status” of Service1.

In such a state, it is assumed that the update requests as illustrated in FIG. 5 were received at a timing that are presumed to be simultaneous. In other words, it is assumed that a request to change the attribute value of the attribute “Port0” of Switch1 to the attribute value “NG” and a request to change the attribute value of the attribute “Status” of Service1 to the attribute value “error” were received. Then, an update pattern as illustrated in FIG. 6 is generated. In other words, as illustrated in FIG. 4, under a condition of “within 3 hops”, for example, (i.e. within “3” that is the number of intermediate configuration items and corresponds to the distance) in the range of CIs that are connected through the relationships, a condition regarding the change by one update request (e.g. which includes attribute values before and after change for a specific attribute of a specific CI) and a warning condition regarding the change by another update request (e.g. which includes an attribute value before change of the specific attribute of the specific CI) are included. For example, a first update pattern is an update pattern that a warning or the like is performed when the attribute value of the attribute “Status” of Service1 is still “normal” in case where the attribute value “OK” of the attribute “Port0” of Switch1 is changed to “NG”. Moreover, a second update pattern is an update pattern that the warning or the like is performed when the attribute value of the attribute “Port0” of Switch1 is still “OK” in case where the attribute value “normal” of the attribute “Status” of Service1 is changed to “error”.

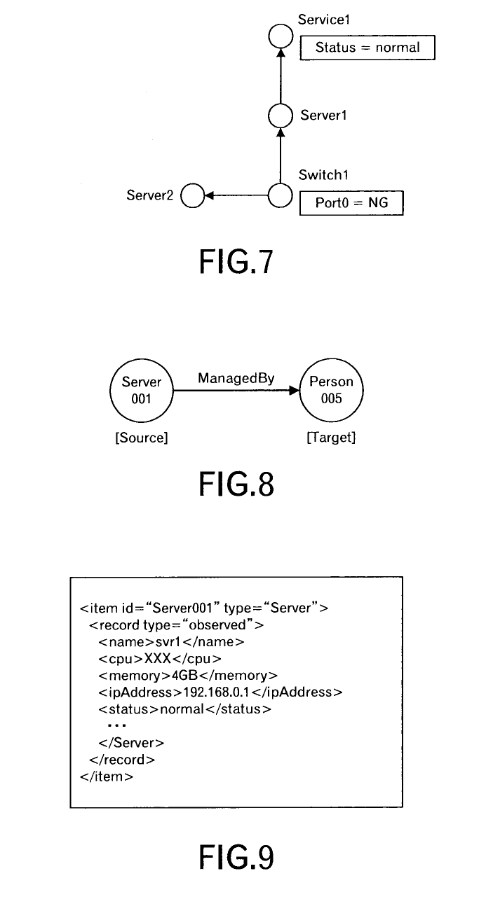

After that, when only an update request to change the attribute value of the attribute “Port0” of Switch1 to “NG” is received at a certain timing, data as illustrated in FIG. 7 is stored in the FCMDB 103. In other words, although “NG” is stored as the attribute value of the attribute “Port0” of Switch1, however, the attribute value of the attribute “Status” of Service1 is still “normal”. Thus, the received update request satisfies a condition of an update pattern in the first line among the update patterns depicted in FIG. 6 and the state of the FCMDB 103 satisfies a warning condition. As described above, when both of the aforementioned condition and the warning condition are satisfied, a predetermined processing such as warning for the administrator is performed.

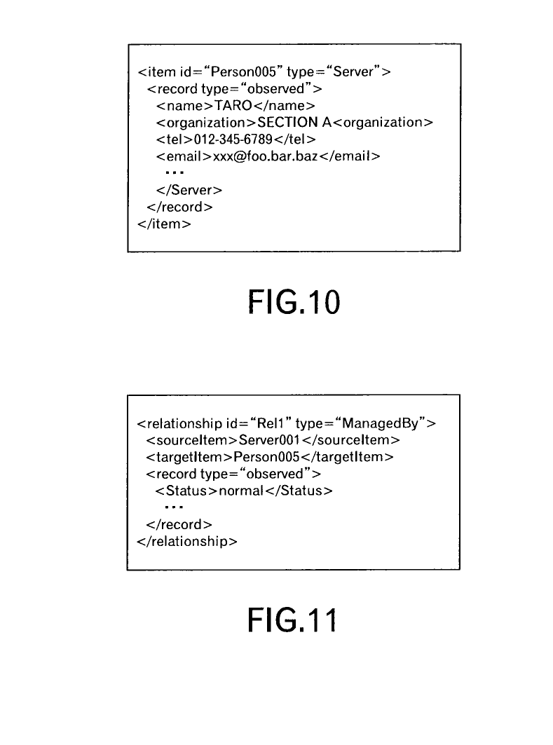

For example, data as described below is stored in the FCMDB 103. For example, as illustrated in FIG. 8, it is assumed that there are a CI “Server001” and a CI “Person005”, and a relationship “ManagedBy” from Server001 to Person005 is set. Then, data as illustrated in FIG. 9 is stored for the CI “Server001”. In other words, a configuration item ID is “Server001”, and Type is “Server”, and an attribute value for each attribute for this configuration item is included. Furthermore, as for the CI “Person005”, data as illustrated in FIG. 10 is stored. In other words, a configuration item ID is “Person005”, and Type is “Server”, and an attribute value for each attribute of this configuration item is included. Furthermore, as for the relationship between these CIs, data as illustrated in FIG. 11 is stored. In other words, a relationship ID is “Rel1”, and Type is “ManagedBy”, and a CI of a source, a CI of a target and attribute values of other attributes for this relationship are included.

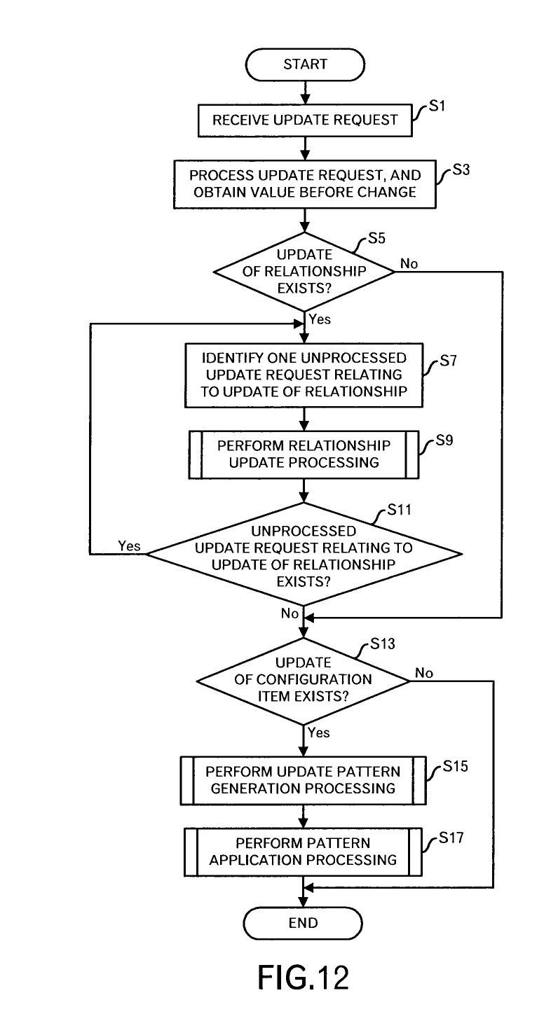

Specific processing contents to perform the update pattern generation and update pattern application, which were simply described above, will be explained by using FIGS. 12 to 23.

Firstly, the update request processing unit 101 of the FCMDB system 100 receives an update request from each MDR, and stores data of the update request into the first data storage unit 102 (FIG. 12: step S1). As described above, a processing is performed collectively for the update requests that are received at predetermined timings that are presumed to be simultaneous, according to a predetermined rule.

Then, the update request processing unit 101 updates the FCMDB 103 according to the update requests (step S3). However, before the update, attribute values before change for the CIs or relationships, which relate to the update requests, are obtained, and stored in the first data storage unit 102.

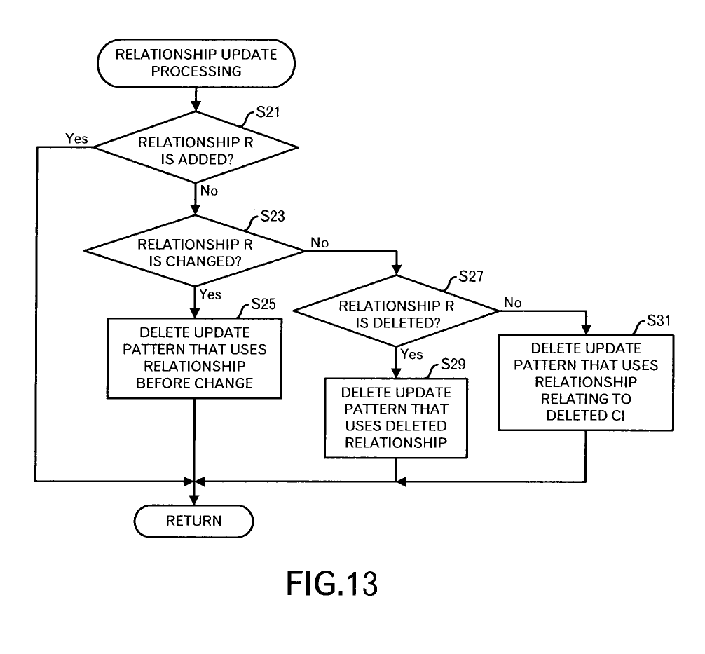

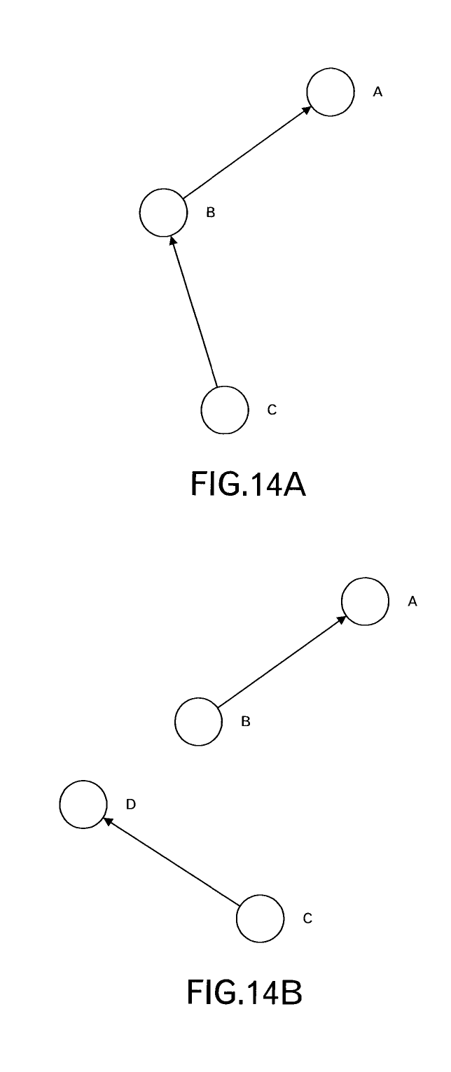

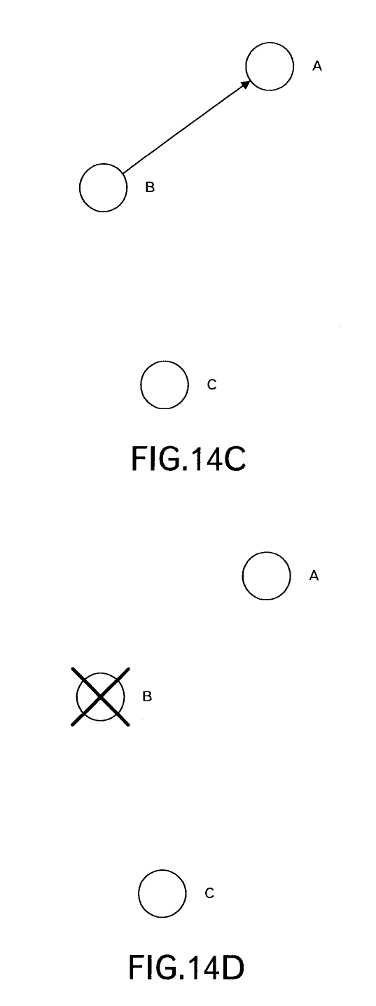

Then, the relation update processing unit 104 determines whether or not the update of the relationship (add, change or delete. Here, the deletion of the CI is included.) is included in the update requests stored in the first data storage unit 102 (step S5). When the update of the relationship is not included in the update requests stored in the first data storage unit 102, the relation update processing unit 104 does not perform any processing, and the processing shifts to step S13. On the other hand, when the update of the relationship is included in the update requests, the relation update processing unit 104 identifies an unprocessed update request relating to the update of the relationship (step S7). Then, the relation update processing unit 104 performs a relation update processing for the identified update request (step S9). The relation update processing will be explained by using FIGS. 13 to 14D.

The relation update processing unit 104 determines whether or not the identified update request is an addition of a relationship R (FIG. 13: step S21). When the identified update request is an addition of the relationship R, no processing is performed and the processing returns to the calling-source processing, because the update request was performed at the step S3. On the other hand, when the identified update request is not the addition of the relationship R, the relation update processing unit 140 determines whether or not the identified update request is a change of the relationship R (step S23). The case where the identified update request is the change of the relationship R includes a case where the target or source of the relationship R is changed and a case where both of the target and source of the relationship Rare changed.

When the identified update request is the change of the relationship R, the relation update processing unit 104 determines whether or not each update pattern stored in the update pattern storage unit 106 is an update pattern that utilizes the relationship before change, and when the update pattern is the update pattern that utilizes the relationship before change, the relation update processing unit 104 deletes the update pattern that utilizes the relationship before change (step S25). Then, the processing returns to the calling-source processing.

As simply described above, in the update pattern, a condition and warning condition are set for two CIs that can be traced along relationships within predetermined hops n. Therefore, there is a case where, when the relationship before change is deleted, it becomes impossible to trace the relationships between the source CI and the target CI within n hops. As illustrated in FIG. 14A, a case is considered that there are CIs A to C, and an update pattern including a condition for C and a warning condition for A. Here, as illustrated in FIG. 14B, by the update request of the relationship, the target for the relationship from C to B is changed to D, and a relationship from C to D is newly set, and the relationship from B to A is maintained. Then, the update pattern including the condition for C and the warning condition for A is deleted, because it becomes impossible to trace the relationship from C to A. A case of changing the source of the relationship and a case of changing both of the source and target is similarly considered. When the relationship R is changed, however, it is possible to trace the relationship through other routes, the update pattern may not be deleted.

Although the update pattern is not generated in the relationship update processing, the relationship from C to D is newly set in FIG. 14B. Therefore, for example, when an update request to change an attribute value of an attribute of C and an update request to change an attribute value of an attribute of D are received, a new update pattern is generated by using these update requests.

When the identified update request is not the change of the relationship R, the relation update processing unit 104 determines whether or not the identified update request is deletion of the relationship R (step S27). When the identified update request is the deletion of the relationship R, the relation update processing unit 104 deletes an update pattern that utilizes the deleted relationship (step S29). Then, the processing returns to the calling-source processing. As illustrated in FIG. 14C, when the relationship from C to B is deleted, it becomes impossible to perform the trace along the relationship from C to A. Therefore, the update pattern including the condition for C and the warning condition for A is deleted.

In this embodiment, the update request to request the deletion of CI is also treated as the update of the relationship. Therefore, when the identified update request is not the deletion of the relationship R, the relation update processing unit 104 deletes an update pattern that utilizes the relationship relating to the deleted CI (step S31). Then, the processing returns to the calling-source processing. As illustrated in FIG. 14D, when B is deleted, the relationship relating to B (relationship from C to B and relationship from B to A) is deleted simultaneously. Therefore, it becomes impossible to perform the trace along the relationship from C to A. Therefore, the update pattern including the condition for C and the warning condition for A is deleted.

By carrying out the aforementioned processing, it is possible to cope with the update pattern that is influenced by the update of the relationship.

Returning to the explanation of the processing in FIG. 12, the relation update processing unit 104 determines whether or not there is an unprocessed update request relating to the update of the relationship (step S11). When there is an unprocessed update request relating to the update of the relationship, the processing returns to the step S7. On the other hand, when there is no unprocessed update request relating to the update of the relationship, the update pattern generator 105 determines whether or not the update of the configuration item CI is included in the update requests in the first data storage unit 102 (step S13). When the update of the configuration item CI is not included in the update requests, the processing ends.

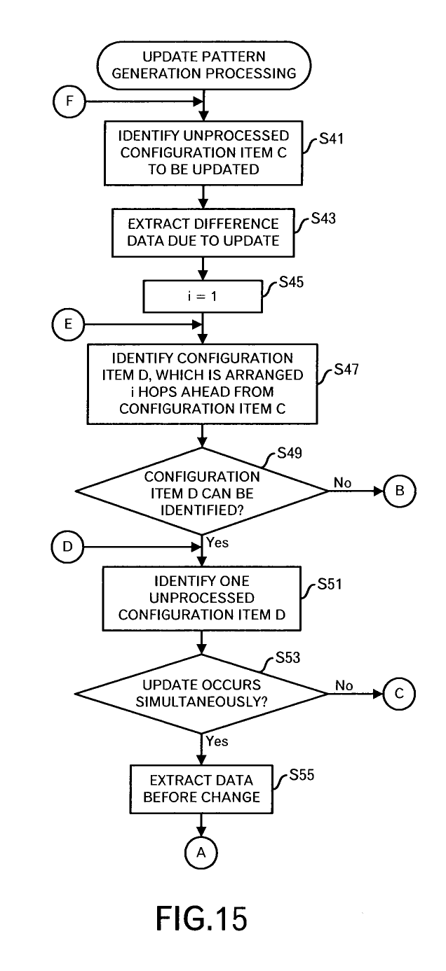

On the other hand, when the update of the configuration item CI is included in the update requests, the update pattern generator 105 performs an update pattern generation processing (step S15). This update pattern generation processing will be explained by using FIGS. 15 to 20. In the update pattern generation processing, the update pattern is not generated when two or more update requests are not stored in the first data storage unit 102. Therefore, the processing may start after firstly confirming whether or not two or more update requests exist at the timings that are presumed to be simultaneous.

The update pattern generator 105 identifies one unprocessed configuration item C to be updated, from the update requests stored in the first data storage unit 102 (FIG. 15: step S41). For example, when the update request in the first line in the example of FIG. 5 is processed, Switch1 is identified as the configuration item C. Then, the update pattern generator 105 extracts difference data due to the update from data before change, which is stored in the first data storage unit 102, and the update request for the configuration item C (step S43).

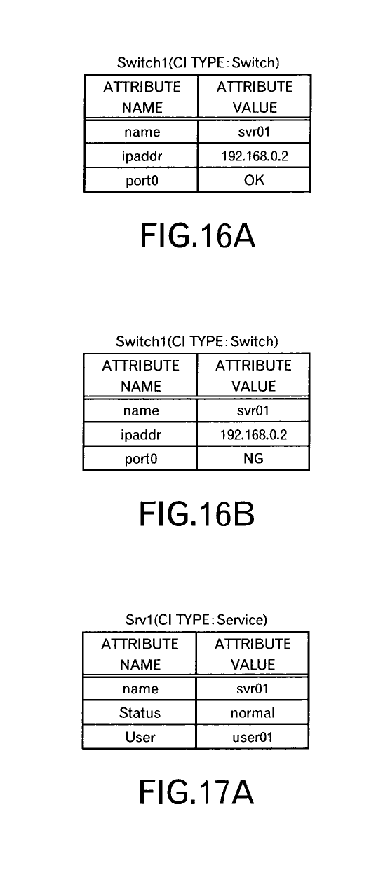

For example, it is assumed that data as illustrated in FIG. 16A is data before the update request for Switch1 is applied to the FCMDB 103. Then, it is assumed that data as illustrated in FIG. 16B is stored in the FCMDB 103. In other words, the attribute value “OK” of the attribute name “Port0” is changed to “NG”. Therefore, data “Switch1/Port0=OK” is stored as data before change in the first data storage unit 102. Then, in this example, the difference data due to the update is identified as “Switch1/Port0=OK->NG”.

Then, the update pattern generator 105 initializes a counter i for the number of hops to “1” (step S45). After that, the update pattern generator 105 identifies the configuration item D that is disposed “i” hops ahead from the configuration item C (step S47). For example, in case of i=1, in FIG. 7, when the relationship is traced only one hop from Switch1, Server1 and Server2 are identified as the configuration item D.

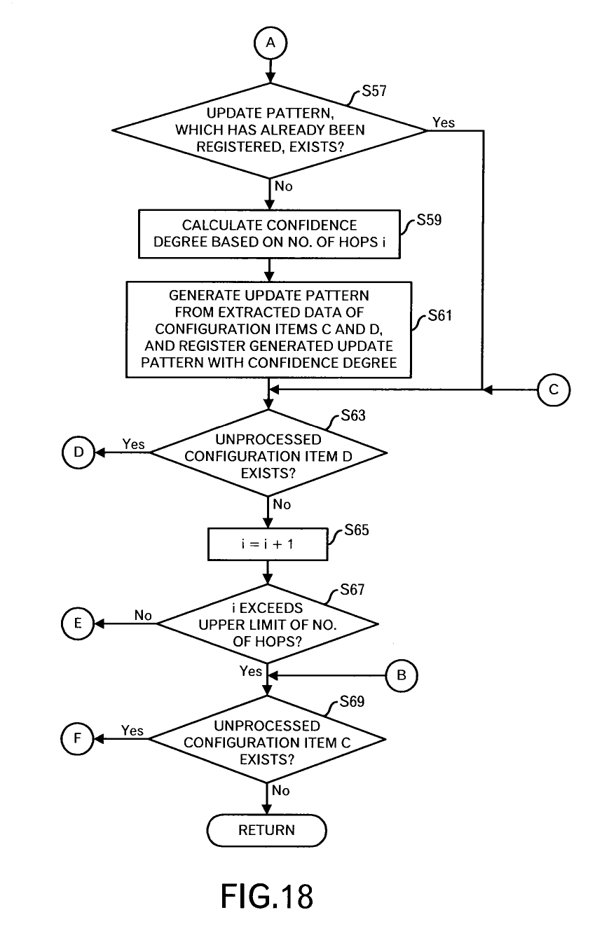

After that, the update pattern generator 105 determines whether or not the configuration item D was identified (step S49). As described above, because the trace is performed only between configuration items for which the relationships between the configuration items are defined, it is impossible to identify the configuration item at the next hop unless the relationship is defined at the edge configuration items such as Service1 and Server2 in FIG. 7. Here, when the configuration item D is not identified, the processing shifts to step S69 in FIG. 18 through terminal B.

On the other hand, when the configuration item D can be identified, the update pattern generator 105 identifies one unprocessed configuration item D (step S51). Then, the update pattern generator 105 determines whether or not the update requests occur simultaneously, by checking whether or not an update request for this configuration item D is stored in the first data storage unit 102 (step S53). When no update request for this configuration item D is stored in the first data storage unit 102, no update occurs simultaneously. Therefore, the processing shifts to step S63 in FIG. 18 through terminal C.

In the example of FIG. 7, because the update request for Server1 or Server2, which is the configuration item D that is disposed 1 hop ahead from Switch1, is not received, the processing shifts to the step S63 in FIG. 18 through the terminal C. On the other hand, in case of i=2, Service1 is identified as the configuration item D, and the update request for this is included in the second line of FIG. 5. Therefore, it is determined that the updates occur simultaneously.

On the other hand, when the update request for this configuration item D is stored in the first data storage unit 102 and the updates occur simultaneously, the update pattern generator 105 extracts data before change for the configuration item D from the first data storage unit 102 (step S55). Then, the processing shifts to a processing in FIG. 18 through terminal A.

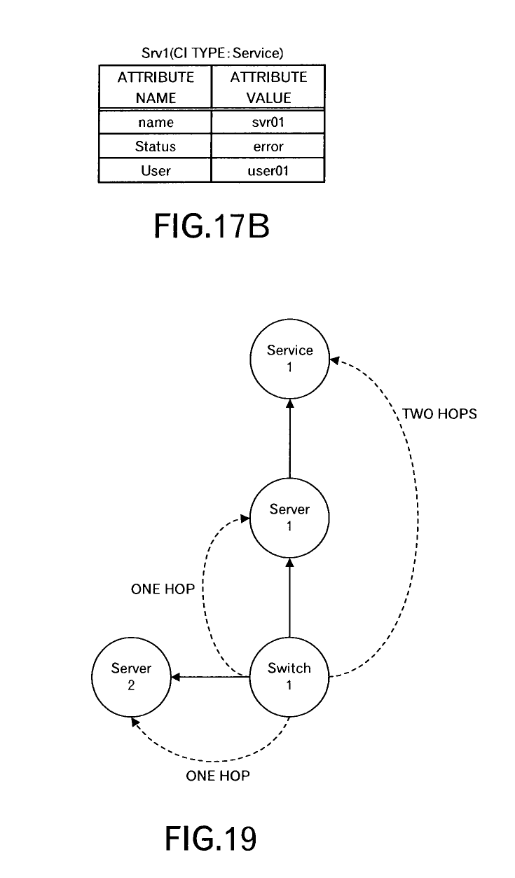

In case of the configuration item Service1, when the update request in the second line of FIG. 5 is not applied to the FCMDB 103, data as illustrated in FIG. 17A is stored in the FCMDB 103. Especially, an attribute value of the attribute name “Status” is “normal”. On the other hand, when the update request in the second line of FIG. 5 is applied to the FCMDB 103, data as illustrated in FIG. 17B is stored in the FCMDB 103. The attribute value of the attribute name “Status” is changed to “error”. Therefore, as the data before change, “Service1/Status=normal” is stored in the first data storage unit 102, and this data is extracted.

Shifting to the explanation of the processing in FIG. 18, the update pattern generator 105 determines whether or not an update pattern including difference data due to the update, which was extracted at the step S43, as the condition and data before change, which was extracted at the step S55, as the warning condition has already been stored in the update pattern storage unit 106 (step S57). When the same update pattern has already been stored, there is no need to duplicately store the update pattern. Therefore, the processing shifts to the step S63.

On the other hand, when the same update pattern has not been registered, the confidence degree calculation unit 1051 of the update pattern generator 105 calculates a confidence degree based on the number of hops i (step S59). In this embodiment, when the configuration item C and configuration item D are nearer, the confidence degree becomes higher. Therefore, when the number of hops i is lesser, the confidence degree becomes higher. Therefore, 1/(the number of hops) is calculated as the confidence degree, for example. As illustrated in FIG. 19, when Switch1 that is the configuration item C is used as the basis, the confidence degree becomes “1” (=1/1), when the configuration item D is Server1 or Server2, because they are placed one hop ahead from the configuration item C. On the other hand, in case where the configuration item D is Service1, the confidence degree becomes “0.5” (=½), because Service1 is the configuration item that is arranged two hops ahead from Switch1.

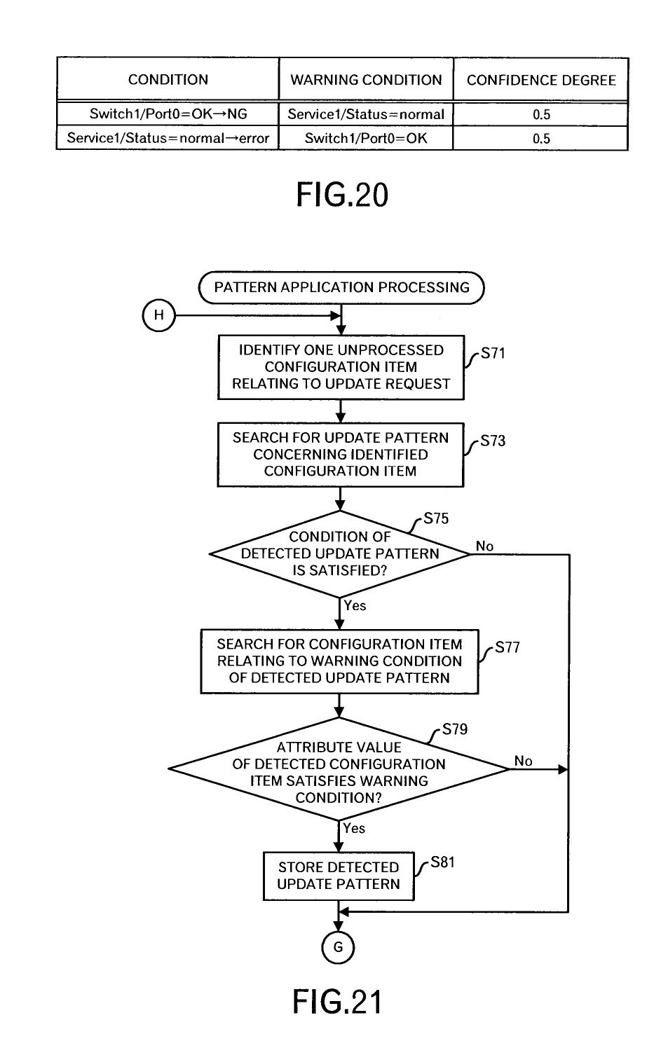

Then, the update pattern generator 105 generates an update pattern including the difference data due to the update, which was extracted at the step S43, as the condition, and including the data before change, which was extracted at the step S55, as the warning condition, from the difference data due to the update, which was extracted at the step S43, and the data before change, which was extracted at the step S55, and stores the generated update pattern and the confidence degree calculated at the step S59, into the update pattern storage unit 106 (step S61). Therefore, in this embodiment, data as illustrated in FIG. 20 is stored. In an example of FIG. 20, the condition, warning condition and confidence degree are stored. When the update request in the first line of FIG. 5 is processed, the update pattern in the first line of FIG. 20 is generated, and when the update request in the second line of FIG. 5 is processed, the update pattern in the second line of FIG. 20 is generated.

The update pattern generator 105 determines whether or not there is an unprocessed configuration item D among configuration items D identified at the step S47 (step S63). When there is an unprocessed configuration item D, the processing returns to the step S51 in FIG. 15 through terminal D. On the other hand, when there is no unprocessed configuration item D, the update pattern generator 105 increments the counter i by “1” (step S65), and determines whether or not i exceeds a preset upper limit value for the number of hops (step S67). When i is equal to or less than the upper limit value for the number of hops, the processing returns to the step S47 in FIG. 15 through terminal E. On the other hand, when i exceeds the upper limit value for the number of hops, the update pattern generator 105 determines whether or not there is an unprocessed configuration item C (step S69). When there is an unprocessed configuration item C, the processing returns to the step S41 in FIG. 15 through terminal F. On the other hand, when there is no unprocessed configuration item C, the processing returns to the calling-source processing.

Thus, as for two update requests, when those configuration items are connected through the relationship and they are placed in a range within the upper limit value for the number of hops, two update patterns are generated. As for three update requests, when those configuration items are connected through the relationships and they are placed in a range within the upper limit value for the number of hops, 6 (=3*2) update patterns are generated.

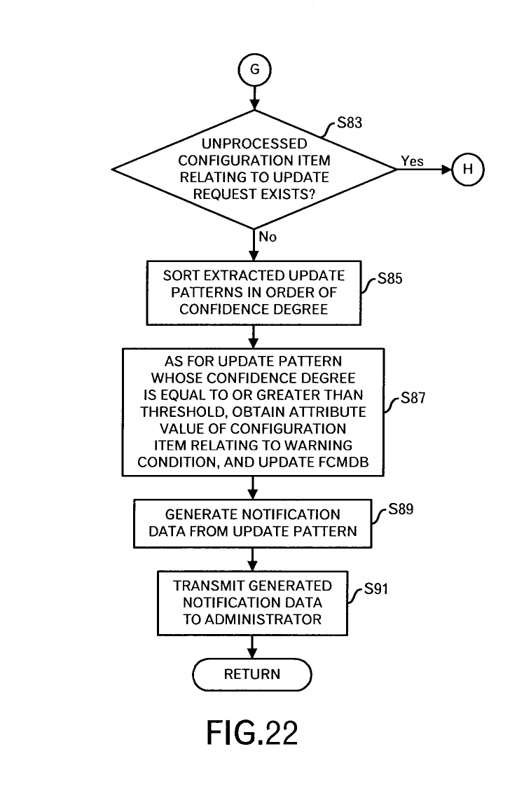

Returning to the processing in FIG. 12, the pattern matching unit 107 performs a pattern application processing (step S17). A processing in FIGS. 21 and 22 may be used for the pattern application processing.

The pattern matching unit 107 identifies one unprocessed configuration item relating to the update requests stored in the first data storage unit 102 (step S71). Then, the pattern matching unit 107 searches the update pattern storage unit 106 for an update pattern for the identified configuration item (step S73).

The pattern matching unit 107 determines whether or not a condition included in the detected update pattern is satisfied (step S75). In this embodiment, because the attribute value before change and the attribute value after change for a specific attribute of the configuration item are included in the condition, it is determined based on the data before change, which is stored in the first data storage unit 102, and the data after change, which is stored in the FCMDB 103, whether or not the condition is satisfied.

When the condition included in the detected update pattern is not satisfied or no update pattern is detected, the processing shifts to a processing in FIG. 22 through terminal G.

On the other hand, when the condition included in the detected update pattern is satisfied, the pattern matching unit 107 searches the FCMDB 103 for the configuration item relating to the warning condition of the detected update pattern (step S77), and reads out an attribute value of an attribute defined in the warning condition for the detected configuration item, and further determines whether or not the read attribute value is identical to the attribute value defined in the warning condition (step S79). Because the attribute value before change is included in the warning condition, it can be determined that the warning condition is satisfied, when the attribute value before change is still registered in the FCMDB 103.

When the attribute value in the FCMDB 103 is not identical to the attribute value included in the warning condition, the processing shifts to the processing in FIG. 22 through the terminal G.

On the other hand, when the attribute value in the FCMDB 103 is identical to the attribute value included in the warning condition, the pattern matching unit 107 stores the detected update pattern in the second data storage unit 108 (step S81). Then, the processing shifts to the processing in FIG. 22 through the terminal G.

Shifting to the explanation of the processing in FIG. 22, the pattern matching unit 107 determines whether or not there is an unprocessed configuration item relating to the update requests in the first data storage unit 102 (step S83). When there is an unprocessed configuration item relating to the update requests, the processing returns to the step S71 in FIG. 21 through terminal H.

On the other hand, when there is not unprocessed configuration item relating to the update requests, the pattern matching unit 107 sorts the update patterns extracted in the aforementioned processing in descending order of the confidence degrees of the update patterns (step S85).

Then, as for the update patterns whose confidence degree is equal to or greater than a threshold, the pattern matching unit 107 obtains an attribute value of an attribute for the configuration item relating to the warning condition from a pertinent MDR, and performs the update for the FCMDB 103 (step S87). As for the update patterns whose confidence degree is equal to or greater than the threshold, the data after change is obtained at this timing from MDR to forcibly update the FCMDB 103, if the arrival of the update request is delayed. If the data after change, which was obtained from MDR, is different from a present value in the FCMDB 103, the update is performed for the FCMDB 103. On the other hand, when the data after change, which was obtained from MDR, is the same as the present value in the FCMDB 103, there is possibility of the omission of the update.

Moreover, the pattern matching unit 107 generates notification data to an administrator from the update pattern stored in the second data storage unit 108 (step S89). The notification data including the condition and the warning condition of the update pattern may be simply generated, and after identifying an attribute of a configuration item that has not been updated from the warning condition of the update pattern, data to prompt the update of the attribute of that configuration item may be generated. The notification data may be generated for the update pattern whose confidence degree is equal to or greater than a second threshold. Furthermore, the update patterns may be narrowed to the top n update patterns in descending order of the confidence degree.

For example, when the attribute “Status” of Service1 in the FCMDB 103 is still “normal”, notification data representing the attribute of Service1 is still “normal”. In such a case, because it is determined at the step S75 that the condition of the update pattern in the second line of FIG. 20 is no satisfied, this update pattern is not registered in the second data storage unit 108.

Then, the pattern matching unit 107 transmits the generated notification data to the administrator who is preregistered (step S91). The notification data may be transmitted via e-mail to the administrator and may be transmitted in response to an access from the user terminal 200. Furthermore, when a monitor program is activated in the user terminal 200, the notification data may be transmitted at real time, and may be displayed on a display device of the user terminal 200 at real time.

When the aforementioned processing is performed, it is possible to appropriately register the update patterns for the update requests that were received at timings that are presumed to be simultaneous, and after that, when an update request that follows this update pattern is not received at the timings that are presumed to be simultaneous, the update pattern that was not followed can be extracted. A processing amount of the matching processing itself is not so much, and the omission of the update can be identified with low processing load.

As described above, the extracted update pattern may be notified to the administrator, and according to the confidence degree, the update for the MDR may be automatically applied to the FCMDB 103. Furthermore, when the gap between the transmission timings of the update requests is a problem, a request to adjust the transmission timing to the MDR side may be sent or a warning to adjust the transmission timing of the update request may be made for the administrator side.

When plural update patterns are detected at the step S73 in FIG. 21, the steps S75 to S81 are repeated for each detected update pattern.

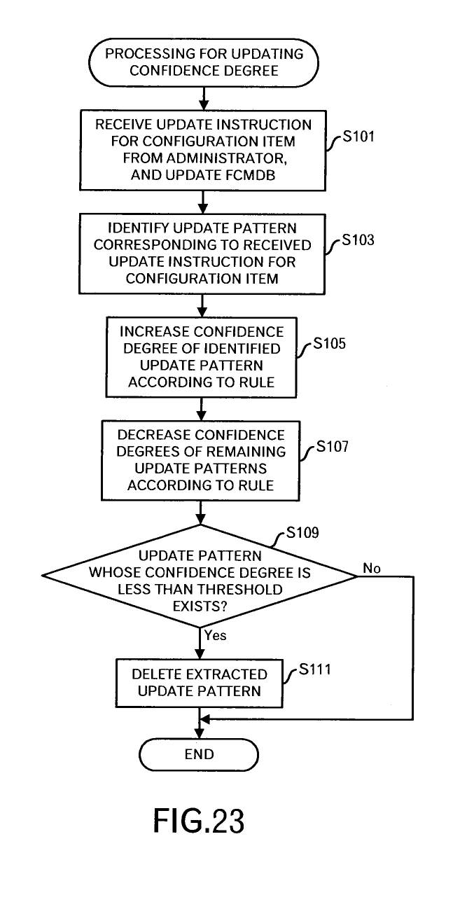

Next, a processing after the administrator confirmed the notification data at the user terminal 200 will be explained by using FIG. 23.

Here, it is assumed that the administrator selects a configuration item of an update pattern to be updated among update patterns included in the notification data that is displayed on the display device of the user terminal 200 (or an attribute of a configuration item, which is included in that warning condition), and inputs an attribute and attribute value after change for the selected configuration item. Then, the user terminal 200 transmits a configuration item update instruction including the configuration item, attribute and attribute value after change to the FCMDB system 100. The configuration item update instruction may include an identifier of the update pattern.

The instruction processing unit 109 receives the configuration item update instruction from the administrator from the user terminal 200 (FIG. 23: step S101). Here, the instruction processing unit 109 updates the FCMDB 103 with the attribute value after change, when the attribute value after change for the attribute of the configuration item, which is included in the configuration item update instruction, has not been registered.

Moreover, the instruction processing unit 109 identifies the update pattern corresponding to the configuration item update instruction among the update patterns stored in the second data storage unit 108 (step S103). The update pattern whose configuration item and attribute, which are included in the warning condition, are identical to the configuration item and attribute, which are included in the configuration item update instruction, is identified. When the configuration item update instruction to change the attribute value of the attribute “Status” of Service1 to the attribute value “error” is received, the update pattern in the second line of FIG. 20 is identified.

Then, the instruction processing unit 109 increases the confidence degree of the identified update pattern according to the predetermined rule (step S105). For example, a predetermined value may be added or a value that is greater than 1 may be multiplied.

Moreover, the instruction processing unit 109 decreases the confidence degree for update patterns (i.e. remaining update patterns) other than the update pattern identified at the step S103 among the update patterns stored in the second data storage unit 108, according to the predetermined rule (step S107). For example, a predetermined value may be subtracted, or a value that is greater than 0 and less than 1 may be multiplied.

Then, at this stage, the instruction processing unit 109 determines whether or not the update pattern whose confidence degree is less than a threshold (e.g. less than 0) is stored in the update pattern storage unit 106 (step S109). When there is the update pattern whose confidence degree is less than the threshold, the instruction processing unit 109 deletes the update pattern whose confidence degree is less than the threshold (step S111). Then, the processing ends. On the other hand, when there is no update pattern whose confidence degree is less than the threshold, the processing ends.

When the processing is carried out up to this step, the instruction processing unit 109 discards data for the update pattern associated with a group of update requests for the configuration items that are presumed to be simultaneously updated among data stored in the second data storage unit 108.

By carrying out the aforementioned processing, when the notification is sent to the administrator, the confidence degree can be decreased for the update pattern for the configuration item for which the update is not instructed by the administrator, and the confidence degree can be increased for the update pattern for the configuration item for which the update is instructed by the administrator. Thus, the update pattern for the configuration item that is updated after the confirmation by the administrator is managed in the update pattern storage unit 106 as the credible update pattern.

Although the embodiments of this technique were explained, this technique is not limited to those.

For example, the format of the update pattern, which was described above, is a mere example, and is not always employed. Specifically, the condition includes the attribute value before change, however, when the change to the attribute value after change is important, the attribute value before change may not be registered. Similarly, the attribute value before change is registered in the warning condition, however, when it is important that the change to the attribute value after change is not made, the attribute value after change may be included in the warning condition instead of the attribute value before change, and it may be determined that the warning condition is satisfied when “a value to be checked is not identical to the attribute value after change”. Furthermore, the warning condition may include the attribute value after change in addition to the attribute value before change. Thus, it may be determined that the warning condition is satisfied when “the change of the attribute value, which is defined in the warning condition, is not correctly performed”.

In the aforementioned example, the update request is initially applied to the FCMDB 103, however, the update request may be applied later. In such a case, because the relationship update processing is performed in a state that the update of the relationship is not performed, a processing to trace the relationship by taking into consideration the update of the relationship relating to the update request is performed. Moreover, whether or not the condition and warning condition are satisfied is determined after confirming the update request that is not applied and the contents of the FCMDB 103.

Furthermore, as long as the processing result does not change, the turn of the processing step may be exchanged, or processing steps may be executed in parallel.

Moreover, the functional block diagram in FIG. 3 is a mere example, and does not always correspond to an actual program module configuration and data keeping mode.

Furthermore, the FCMDB system 100 may be implemented by one or plural computers.

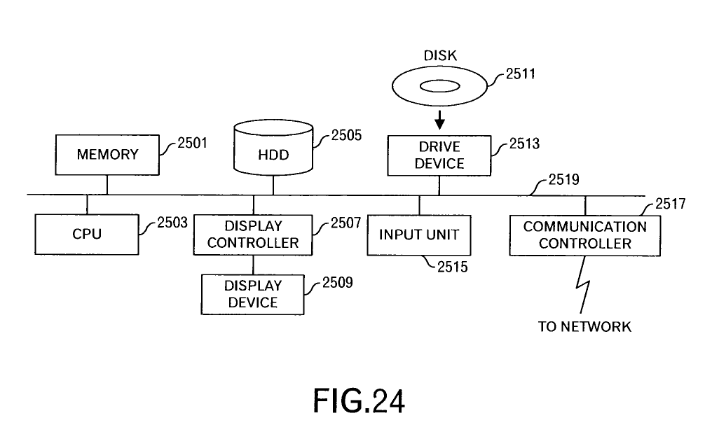

In addition, the aforementioned FCMDB system 100 is a computer device as illustrated in FIG. 24. That is, a memory 2501 (storage device), a CPU 2503 (processor), a hard disk drive (HDD) 2505, a display controller 2507 connected to a display device 2509, a drive device 2513 for a removable disk 2511, an input unit 2515, and a communication controller 2517 for connection with a network are connected through a bus 2519 as illustrated in FIG. 24. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

The aforementioned embodiments are outlined as follows:

A pattern application method relating to a first aspect of the embodiments includes (A) upon receiving a request to change an attribute value of a certain attribute for a certain configuration item included in a system, determining whether there is a first pattern that includes a first condition, which is satisfied with change relating to the request, among plural patterns, wherein each of the plural patterns includes a first condition relating to a certain change of an attribute value of an attribute for a first configuration item included in the system and a second condition relating to an attribute value of an attribute, which is to be changed at a same timing as the certain change, for a second configuration item that has a predetermined relation with the first configuration item; (B) upon determining that there is the first pattern, determining whether a second condition of the first pattern is satisfied, based on at least either of another request to be processed with the request and a data storage unit that stores information of configuration items included in the system and whose information of the configuration items is updated by the request; and (C) upon determining the second condition of the first pattern is satisfied, performing a predetermined processing.

Thus, it is possible to confirm whether or not updates for plural configuration items are performed at the same timing along a pattern that represents the simultaneous updates, and when the updates for plural configuration items are not performed at the same timing along the pattern that represents the simultaneous updates, there is omission of the update. Therefore, it becomes possible to notify a user such as an administrator or automatically perform the update. The processing load of such a matching processing is not so high, and it becomes possible to extract the problem at low processing load.

Moreover, the aforementioned pattern may include a confidence degree of the pattern. In such a case, the aforementioned predetermined processing may include: upon detecting there are plural first patterns whose first and second conditions are satisfied, generating data to be notified to an administrator, for at least one of the first patterns whose first and second conditions are satisfied, according to the confidence degree. Thus, the administrator can perform various kinds of actions after confirming the omission of the update. When the first patterns are displayed in descending order of the confidence degree for the administrator, it is possible to take any action for much reliable omission of the update.

Furthermore, the aforementioned pattern may include a confidence degree of the pattern. In such a case, the predetermined processing may include: upon detecting that a confidence degree of the first pattern whose first and second conditions are satisfied is equal to or greater than a threshold, obtaining data of an attribute defined in the second condition of the first pattern whose first and second conditions are satisfied, from a second data storage unit that stores information that is an origin of the information of the configuration items, which is stored in the data storage unit. By carrying out such a processing, it becomes possible to cope with a case where the delay of the update occurs. When the confidence degree is high, there is a case where the update of the data storage unit can be performed automatically.

Furthermore, this pattern application method may include: increasing a confidence degree of a first pattern, for which change of an attribute relating to a second condition is instructed by the administrator, among the plural first patterns whose first and second conditions are satisfied and that were notified to the administrator; and decreasing a confidence degree of a pattern for which change of the attribute relating to the second condition is not instructed by the administrator. By updating the confidence degree as described above, it is possible to extract much credible patterns.

Moreover, a pattern generation method relating to a second aspect of the embodiments includes: (A) determining, for each of plural requests, each of which an attribute value of an attribute for a configuration item included in a system is to be changed, whether it is possible to reach a configuration item relating to another request of the plural requests from a configuration item relating to the request, by tracing one or plural relationships between configuration items, within a predetermined range among predefined relationships among configuration items included in the system, wherein the plural requests are received at predetermined timings that are presumed to be simultaneous; and (B) upon determining that it is possible to reach a first configuration item relating to a first request of the plural requests from a second configuration item relating to a second request, generating a pattern that includes a first condition relating to change of an attribute value of an attribute for the second configuration item relating to the second request and a second condition relating to change of an attribute value of an attribute for the first configuration item relating to the first request.

Thus, a pattern that represents the simultaneous update is generated for configuration items whose association is guaranteed to some degree.

Moreover, the first condition may include attribute values before and after change or the attribute value after change, and the second condition may include an attribute value before change, an attribute value after change, or attribute values before and after change. It is possible to variously define the aforementioned first and second conditions.

Furthermore, the pattern generation method relating to the second aspect of the embodiments may include: upon receiving a request to change or delete a relationship between configuration items included in the system or a request to delete any configuration item, deleting a pattern that was generated by tracing a relationship defined for the relationship before change, the deleted relationship, or deleted configuration item. When the relationship is changed or deleted, a case occurs that the relationship between configuration items cannot be traced. This processing is carried out for this case.

Furthermore, the pattern generation method relating to the second aspect of the embodiments may include: calculating a confidence degree according to the number of configuration items, through which the tracing is performed from the second configuration item to the first configuration item, and storing the calculated confidence degree in association with the pattern. For example, a reciprocal of the number of configuration items, which is described above, may be employed as the confidence degree. In other words, a higher confidence degree may be set for the pattern for the nearer configuration item. Thus, it also becomes possible to extract a pattern that is much reliable when the matching processing is performed.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A non-transitory computer-readable storage medium storing a program for causing a computer to execute a process, comprising:
upon receiving a request to change an attribute value of a certain attribute for a certain configuration item included in a system, determining whether there is a first pattern that includes a first condition, which is satisfied with change relating to the request, among a plurality of patterns, wherein each of the plurality of patterns includes a first condition relating to a certain change of an attribute value of an attribute for a first configuration item included in the system and a second condition relating to an attribute value of an attribute, which is to be changed at a same timing as the certain change, for a second configuration item that has a predetermined relation with the first configuration item;
upon determining that there is the first pattern, determining whether a second condition of the first pattern is satisfied, based on at least either of another request to be processed with the request and a data storage unit that stores information of configuration items included in the system and whose information of the configuration items is updated by the request; and
upon determining the second condition of the first pattern is satisfied, performing a predetermined processing.

2. The non-transitory computer-readable storage medium as set forth in claim 1, wherein each of the plurality of patterns includes a confidence degree, and
the predetermined processing comprises:
upon detecting there are plural first patterns whose first and second conditions are satisfied, generating data to be notified to an administrator, for at least one of the first patterns whose first and second conditions are satisfied, according to the confidence degree.

3. The non-transitory computer-readable storage medium as set forth in claim 1, wherein each of the plurality of patterns includes a confidence degree, and
the predetermined processing comprises:
upon detecting that a confidence degree of the first pattern whose first and second conditions are satisfied is equal to or greater than a threshold, obtaining data of an attribute defined in the second condition of the first pattern whose first and second conditions are satisfied, from a second data storage unit that stores information that is an origin of the information of the configuration items, which is stored in the data storage unit.

4. The non-transitory computer-readable storage medium as set forth in claim 2, wherein the process further comprises:
increasing a confidence degree of a first pattern, for which change of an attribute relating to a second condition is instructed by the administrator, among the plurality of first patterns whose first and second conditions are satisfied and that were notified to the administrator; and
decreasing a confidence degree of a pattern for which change of the attribute relating to the second condition is not instructed by the administrator.

5. A non-transitory computer-readable storage medium storing a program for causing a computer to execute a process, comprising:
determining, for each of a plurality of requests, each of which an attribute value of an attribute for a configuration item included in a system is to be changed, whether it is possible to reach a configuration item relating to another request of the plurality of requests from a configuration item relating to the request, by tracing one or plural relationships between configuration items, within a predetermined range among predefined relationships among configuration items included in the system, wherein the plurality of requests are received at predetermined timings that are presumed to be simultaneous; and
upon determining that it is possible to reach a first configuration item relating to a first request of the plurality of requests from a second configuration item relating to a second request, generating a pattern that includes a first condition relating to change of an attribute value of an attribute for the second configuration item relating to the second request and a second condition relating to change of an attribute value of an attribute for the first configuration item relating to the first request.

6. The non-transitory computer-readable storage medium as set forth in claim 5, wherein the first condition includes attribute values before and after change or the attribute value after change, and the second condition includes an attribute value before change, an attribute value after change, or attribute values before and after change.

7. The non-transitory computer-readable storage medium as set forth in claim 5, wherein the process further comprises:
calculating a confidence degree according to the number of configuration items, through which the tracing is performed from the second configuration item to the first configuration item.

8. An information processing method, comprising:
upon receiving a request to change an attribute value of a certain attribute for a certain configuration item included in a system, determining, by using a computer, whether there is a first pattern that includes a first condition, which is satisfied with change relating to the request, among a plurality of patterns, wherein each of the plurality of patterns includes a first condition relating to a certain change of an attribute value of an attribute for a first configuration item included in the system and a second condition relating to an attribute value of an attribute, which is to be changed at a same timing as the certain change, for a second configuration item that has a predetermined relation with the first configuration item;
upon determining that there is the first pattern, determining, by using a computer, whether a second condition of the first pattern is satisfied, based on at least either of another request to be processed with the request and a data storage unit that stores information of configuration items included in the system and whose information of the configuration items is updated by the request; and
upon determining the second condition of the first pattern is satisfied, performing, by using a computer, a predetermined processing.

9. An information processing method, comprising:
determining, by using a computer and for each of a plurality of requests, each of which an attribute value of an attribute for a configuration item included in a system is to be changed, whether it is possible to reach a configuration item relating to another request of the plurality of requests from a configuration item relating to the request, by tracing one or plural relationships between configuration items, within a predetermined range among predefined relationships among configuration items included in the system, wherein the plurality of requests are received at predetermined timings that are presumed to be simultaneous; and
upon determining that it is possible to reach a first configuration item relating to a first request of the plurality of requests from a second configuration item relating to a second request, generating, by using the computer, a pattern that includes a first condition relating to change of an attribute value of an attribute for the second configuration item relating to the second request and a second condition relating to change of an attribute value of an attribute for the first configuration item relating to the first request.

10. An information processing apparatus, comprising:
a memory; and
a processor configured to use the memory and execute a process, comprising:
upon receiving a request to change an attribute value of a certain attribute for a certain configuration item included in a system, determining whether there is a first pattern that includes a first condition, which is satisfied with change relating to the request, among a plurality of patterns, wherein each of the plurality of patterns includes a first condition relating to a certain change of an attribute value of an attribute for a first configuration item included in the system and a second condition relating to an attribute value of an attribute, which is to be changed at a same timing as the certain change, for a second configuration item that has a predetermined relation with the first configuration item;
upon determining that there is the first pattern, determining whether a second condition of the first pattern is satisfied, based on at least either of another request to be processed with the request and a data storage unit that stores information of configuration items included in the system and whose information of the configuration items is updated by the request; and
upon determining the second condition of the first pattern is satisfied, performing a predetermined processing.

11. An information processing apparatus, comprising:
a memory; and
a processor configured to use the memory and execute a process, comprising:
determining, for each of a plurality of requests, each of which an attribute value of an attribute for a configuration item included in a system is to be changed, whether it is possible to reach a configuration item relating to another request of the plurality of requests from a configuration item relating to the request, by tracing one or plural relationships between configuration items, within a predetermined range among predefined relationships among configuration items included in the system, wherein the plurality of requests are received at predetermined timings that are presumed to be simultaneous; and
upon determining that it is possible to reach a first configuration item relating to a first request of the plurality of requests from a second configuration item relating to a second request, generating a pattern that includes a first condition relating to change of an attribute value of an attribute for the second configuration item relating to the second request and a second condition relating to change of an attribute value of an attribute for the first configuration item relating to the first request.
